(19) United States
(12) Patent Application Publication
(10) Pub. No.: US 2012/0060178 A1
(43) Pub. Date: Mar. 8, 2012

(54) Continuable communication management apparatus and continuable communication managing method

(75) Inventors: Yu Minakuchi, Kawasaki (JP); Tomotaka Endo, Kawasaki (JP)

(73) Assignee: FUJITSU LIMITED, Kawasaki (JP)

(21) Appl. No.: 13/137,721

(22) Filed: Sep. 7, 2011

(30) Foreign Application Priority Data
Sep. 8, 2010 (JP) 2010-201170

(51) Int. Cl. H04N 7/173; H04N 7/16

(52) U.S. Cl. 725/25; 725/93

(57) ABSTRACT

A continuable communication management apparatus includes a viewing manage that, upon receiving view information representing a reproduction state of video content from an arbitrary view terminal, registers the view information; a video list provider that, in response to a video list request transmitted from a view terminal, accesses a menu server to acquire the video list, determines if there is video content with a suspended state designated by the view terminal in the view information, and if there is the video content with the suspended state, adds the video content with the suspended state as a candidate of continuable viewing to the video list, and transmit the added video list to the view terminal; and a reporting device that finds an information item containing an indication of a view location of the video content with the suspended state from the view information and transmits the information item to the view terminal.

### CROSS-REFERENCE TO RELATED APPLICATION

This application is based upon and claims the benefit of the earlier filing date of Japanese Patent Application No. 2010-201170 filed on Sep. 8, 2010, the entire contents of which are incorporated herein by references.

### FIELD

The embodiment discussed herein is related to a continuable communication management apparatus and a continuable communication management method.

### BACKGROUND

Video content distribution services for providing video contents upon receiving requests from user devices (i.e., view terminals) have conventionally been known, and for example, video streaming services for mobile phones or network TV receivers via an IP (Internet Protocol) network are currently provided. See, for example, Patent Documents 1 and 2 listed below.

FIG. 1 illustrates an exemplary structure of a conventional system. In this figure, a mobile phone video distribution server 2, a mobile phone menu server 3, a network TV video distribution server 4, and a network TV menu server 5 are connected to a network 1 such as the Internet. The mobile phone video distribution server 2 functions as a streaming server to provide video content in response to requests from mobile phones via the network 1. The mobile phone menu server 3 functions as a Web server to provide video list data in response to a request from a mobile phone via the network 1. The network TV video distribution server 4 functions as a streaming server to provide video content in response to requests from network TV receivers via the network 1. The network TV menu server 5 functions as a Web server to provide video list data in response to a request from a network TV receiver via the network 1.

To the network 1 is also connected a network 6 provided by a mobile phone operator and a network 7 provided by an internet service provider (ISP). A first view terminal 8, which is a mobile phone, is connected to the mobile phone video distribution server 2 and the mobile phone menu server 3 via the network 6 and the network 1. A second view terminal 9, which is a network TV receiver, is connected to the network TV video distribution server 4 and the network TV menu server 5 via the network 7 and the network 1.

FIG. 2 illustrates a structure of the major part of the video distribution server (the mobile phone video distribution server 2 or the network TV video distribution server 4). The mobile phone video distribution server 2 or the network TV video distribution server 4 has a communicating part 21 (or 41) that carries out telecommunications via the network, a video distribution part 22 (or 42) that streams video content to a requester, and an authentication part 23 (or 43) that performs an authentication process when authentication is required to access the server.

FIG. 3 illustrates the structure of the major part of the video menu server (the mobile phone menu server 3 or the network TV menu server 5). The mobile phone menu server 3 or the network TV menu server 5 has a communicating part 31 (or 51) that carries out telecommunication via the network, a Web server 32 (or 52) that provides a Web page to a requester, and an authentication part 33 (or 53) that performs an authentication process when authentication is required to access the server.

FIG. 4 illustrates a structure of the major part of a mobile phone used as the first view terminal 8. In FIG. 4, the first view terminal 8 has an antenna 80 for transmitting and receiving radio waves, a packet communication part 81 for carrying out packet communication via a wireless channel, a manipulation input device 82 for inputting user's manipulations, and a Web browser 83 for allowing the user to access Web servers for browsing Web pages. The first view terminal 8 also has a video player 84 for reproducing acquired video contents, and a decoder 85 for decompressing compressed data during reproduction of the video contents.

FIG. 5 illustrates a structure of the major part of a network television receiver (referred to as “network TV receiver”) used as the second view terminal 9. In FIG. 5, the second view terminal 9 has a communicating part 91 for carrying out packet communications via a network, a manipulation input device 92 for inputting user's manipulations, and a Web browser 93 for allowing the user to access Web servers for browsing Web pages. The second view terminal 9 also has a video player 94 for reproducing acquired video contents, and a decoder 95 for decompressing compressed data during reproduction of the video contents.

FIG. 6A and FIG. 6B are sequence diagrams illustrating a process performed in a conventional system to allow video content to be viewed on a mobile phone.

In FIG. 6A, when a user manipulates the manipulation input device 82 of the first view terminal (mobile phone) 8 to input VOD (Video on Demand) request (S101), the Web browser 83 transmits a video list request to the mobile phone menu server 3 (S102).

In response to the request, the Web server 32 of the mobile phone menu server 3 transmits the requested video list to the Web browser 83 of the first view terminal 8 (S103).

The Web browser 83 of the first view terminal 8 displays the received video list (S104), and hence the video list is displayed on the first view terminal 8 (S105).

When a program is selected by the user from the video list, the Web browser 83 of the first view terminal 8 transmits a request for a metafile that contains the URL of the selected video content to the mobile phone menu server 2 (S106).

In response to the metafile request, the Web server 32 of the mobile phone menu server 3 transmits the requested metafile to the Web browser 83 of the first view terminal 8 (S107).

Then, in FIG. 6B, the video player 84 of the first view terminal 8 transmits a request for the video content specified in the metafile to the mobile phone video distribution server 2 (S108).

In response to the request, the video distribution part 22 of the mobile phone video distribution server 2 streams the requested video content to the first view terminal 8 (S109).

The video player 84 and the decoder 85 of the first view terminal 8 decompress and reproduce the compressed video content received at the first view terminal 8 (S110). Hence, the video content is viewed on the first view terminal 8 (S111).

FIG. 7 is a modification of the process sequence for viewing video content on a mobile phone when an authentication procedure is performed in the conventional system. The authentication step is inserted between steps S106 and S107 in FIG. 6A. The other steps are the same as those illustrated in FIG. 6A and FIG. 6B.

In FIG. 7, after the transmission of the metafile request from the first view terminal 8 via the Web browser 83 (S106), the authentication part 33 of the mobile phone menu server 3 requests the Web browser 83 of the first view terminal 8 to provide the user ID and the password (S121).

In response to the request, the Web browser 83 of the first view terminal 8 transmits the user ID and the password to the authentication part 33 of the mobile phone menu server 3, upon input of these information items by the user (S122).

If the authentication procedure is successfully carried out, the Web server 32 of the mobile phone menu server 3 transmits the requested metafile to the Web browser 83 of the first view terminal 8 (S107).

FIG. 8A and FIG. 8B are sequence diagrams illustrating an example of a process performed in a conventional system to allow video content to be viewed on a network TV receiver.

In FIG. 8A, when a user manipulates the manipulation input device 92 of the second view terminal (network TV receiver) 9 to input a VOD (Video on Demand) request (S201), the Web browser 93 transmits a video list request to the network TV menu server 5 (S202).

In response to the request, the Web server 52 of the network TV menu server 5 transmits the requested video list to the Web browser 93 of the second view terminal 9 (S203).

The Web browser 93 of the second view terminal 9 displays the received video list (S204), and hence the video list is displayed on the second view terminal 9 (S205).

When a program is selected by the user from the video list, the Web browser 93 of the second view terminal 9 transmits a request for metafile that contains the URL of the selected video content to the network TV menu server 2 (S206).

In response to the metafile request, the Web server 52 of the network TV menu server 5 transmits the requested metafile to the Web browser 93 of the second view terminal 9 (S207).

Then, in FIG. 8B, the video player 94 of the second view terminal 9 transmits a request for the video content specified in the metafile to the network TV video distribution server 4 (S208).

In response to the request, the video distribution part 42 of the network TV video distribution server 4 streams the requested video content to the second view terminal 9 (S209).

The video player 94 and the decoder 95 of the second view terminal 9 decompress and reproduce the compressed video content received at the second view terminal 9 (S210).

Under the user's manipulation, the video player 94 of the second view terminal 9 transmits a fast-forward request to the network TV video distribution server 4 to skip the scenes already viewed (S211) and receives the streamed data. Hence, the video content is viewed on the second view terminal 9 (S212).

FIG. 9 is a modification of the process sequence for viewing a video content on a network TV receiver when authentication procedure is performed in the conventional system. The authentication step is inserted between steps S206 and S207 in FIG. 8A. The other steps are the same as those illustrated in FIG. 8A and FIG. 8B.

In FIG. 9, after the transmission of the metafile request from the second view terminal 9 via the Web browser 93 (S206), the authentication part 53 of the network TV menu server 5 requests the Web browser 93 of the second view terminal 9 to provide the user ID and the password (S221).

In response to the request, the Web browser 93 of the second view terminal 9 transmits the user ID and the password to the authentication part 53 of the network TV menu server 5, upon input of these information items by the user (S222).

If the authentication procedure is successfully carried out, the Web server 52 of the network menu server 5 transmits the requested metafile to the Web browser 93 of the second view terminal 8 (S207).

The above-described conventional technique does not consider the situation where a same video content is to be viewed by the user at a different view terminal some time later, and therefore, user-friendliness is unsatisfactory.

For instance, a user is watching video content such as a film on the mobile phone on his/her way back home, and may wish to watch the rest of the film on the wide screen of the network TV receiver at a later time. In this case, the user has to take some troublesome steps, such as:
(1) powering on the network TV set,
(2) calling up the website of a video content provider,
(3) executing prescribed authentication procedures such as login procedures,
(4) looking for the target video content the user has been previously watching from the list,
(5) resuming reproduction, and
(6) fast forwarding the content to the view location to start watching.

### LIST OF DOCUMENTS

Patent Document 1: Japanese Laid-open Patent Publication No. 2007-6235
Patent Document 2: Japanese Laid-open Patent Publication No. 2009-55099 A

### SUMMARY

According to one aspect of the embodiment, there is provided a continuable communication management apparatus connected to a video content distribution system that includes a video distribution server configured to distribute requested video content via a network and view terminals configured to receive and reproduce the distributed video content. The continuable communication management apparatus includes:

a communication device to receive view information representing a reproduction state of a video content from an arbitrary view terminal;

a viewing manager to register the view information;

a video list provider to, in response to a video list request transmitted from a view terminal, access a menu server to acquire the video list, determine if there is a video content with a suspended state designated by a user of the view terminal in the view information, and if there is a video content with the suspended state, add the video content with the suspended state as a candidate of continuable view to the video list, and transmit the added video list to the view terminal; and

a reporting device to find an information item containing an indication of a view location of the video content with the suspended state from the view information and report the information item to the view terminal that requested the video list.

The object and advantages of the invention will be realized and attained by means of the elements and combinations particularly described in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a schematic diagram illustrating a structure of a conventional system;

FIG. 2 is a schematic diagram illustrating a structure of the major part of a conventional video distribution server;

FIG. 3 is a schematic diagram illustrating a structure of the major part of a conventional video menu server;

FIG. 4 is a schematic diagram illustrating a structure of the major part of a mobile phone used as a first view terminal in a conventional system;

FIG. 5 is a schematic diagram illustrating a structure of the major part of a network TV receiver used as a second view terminal in a conventional system;

FIG. 6A is a sequence diagram illustrating a part of a process for allowing a user to view a video content on a mobile phone in a conventional system;

FIG. 6B is a sequence diagram continued from FIG. 6A and illustrating the rest of the process in the conventional system;

FIG. 7 is a modified process when authentication is performed to watch video content on a mobile phone in the conventional system;

FIG. 8A is a sequence diagram illustrating a part of a process for allowing a user to view a video content on a network TV receiver in a conventional system;

FIG. 8B is a sequence diagram continued from FIG. 8A and illustrating the rest of the process in the conventional system;

FIG. 9 is a modified process when authentication is performed to watch video content on a network TV receiver in the conventional system;

FIG. 10 is a schematic diagram illustrating a structure of a system according to an embodiment of the invention;

FIG. 11 is a schematic diagram illustrating a structure of the major part of a continuable communication management server;

FIG. 12A illustrates an example of data items held in the Web server device of the continuable communication management server;

FIG. 12B illustrates an example of data items held in the Web server device of the continuable communication management server;

FIG. 12C illustrates an example of data items held in the Web server device of the continuable communication management server;

FIG. 13 illustrates an example of data items held in the viewing state management part of the continuable communication management server;

FIG. 14 illustrates an example of data items held in the authentication part of the continuable communication management server;

FIG. 15 illustrates an example of a list of continuable communication management servers held in a view terminal;

FIG. 16A is a sequence diagram illustrating a part of a process for allowing a user to view video content on a mobile phone according to an embodiment of the invention;

FIG. 16B is a sequence diagram continued from FIG. 16A and illustrating a part of the process according to the embodiment of the invention;

FIG. 16C is a sequence diagram continued from FIG. 16B and illustrating a part of the process according to the embodiment of the invention;

FIG. 17 illustrates an example of the data structure of a communication message;

FIG. 18A illustrates an example of a video list displayed on a mobile phone;

FIG. 18B illustrates an example of a video list displayed on a mobile phone;

FIG. 19 is a sequence diagram of streaming video content to a mobile phone when authentication is performed;

FIG. 20A is a sequence diagram illustrating a part of a process for allowing a user to view video content on a network TV receiver according to an embodiment of the invention;

FIG. 20B is a sequence diagram continued from FIG. 20A and illustrating a part of the process according to the embodiment of the invention;

FIG. 20C is a sequence diagram continued from FIG. 20B and illustrating a part of the process according to the embodiment of the invention;

FIG. 21 is a sequence diagram of streaming video content to a network TV receiver when authentication is performed;

FIG. 22 is a sequence diagram illustrating how the content watching process is finished on a view terminal; and

FIG. 23 is a sequence diagram of checking expiration of the viewing state management data performed by the continued communication management server.

### DESCRIPTION OF EMBODIMENTS

A description is given below, with reference to the attached drawings.

### <Structure>

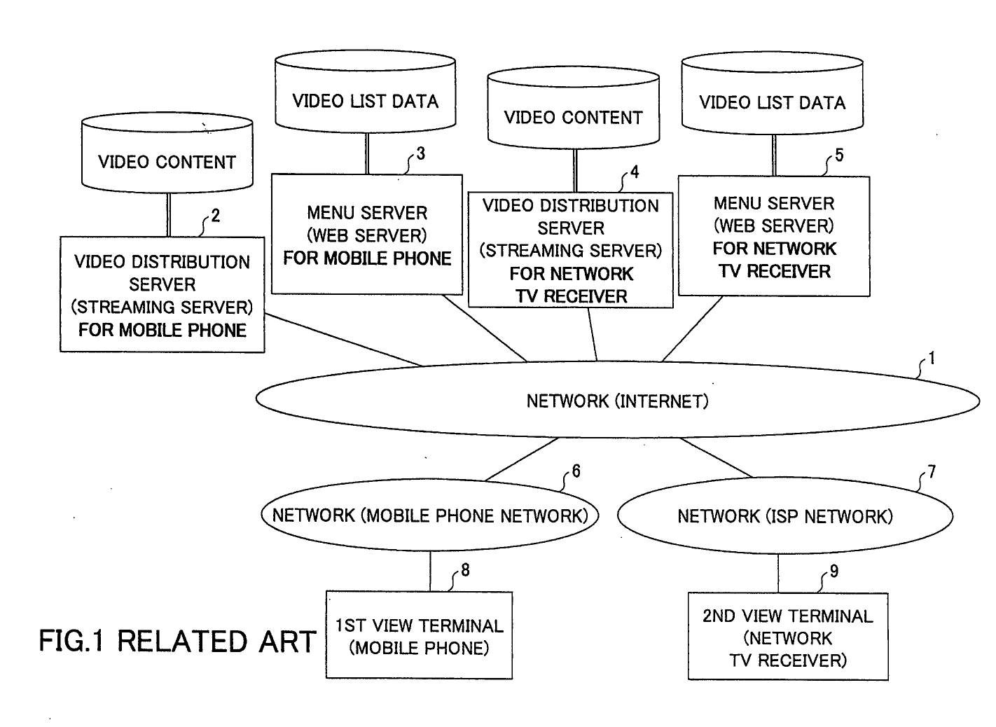

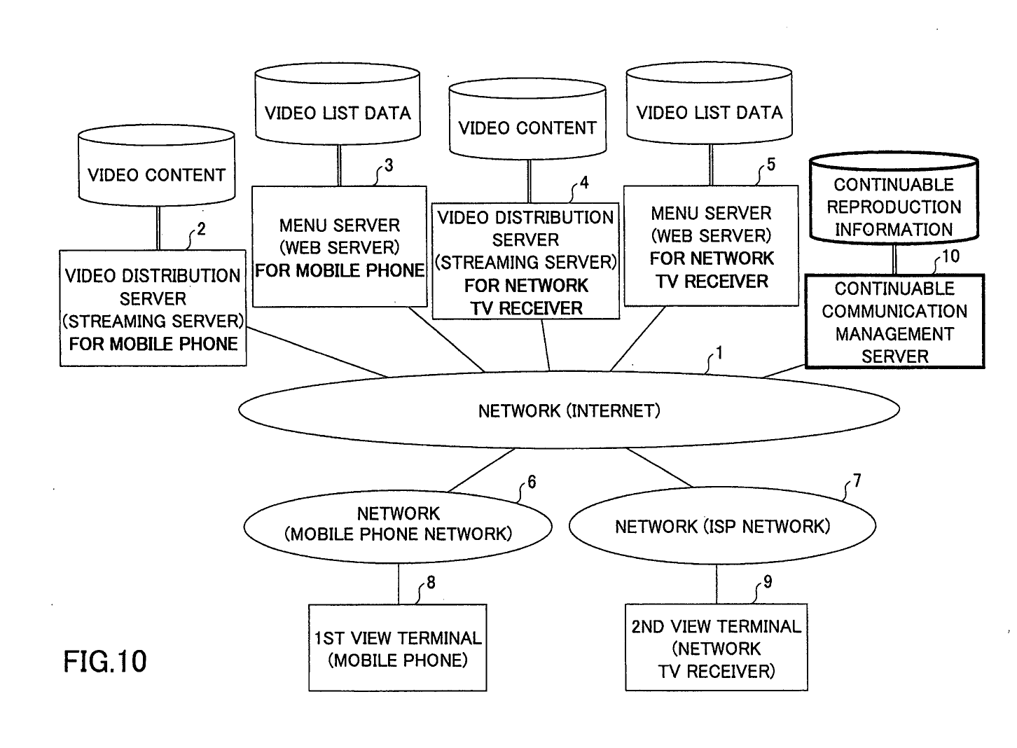

FIG. 10 illustrates a structure of the system according to an embodiment of the invention. The system shown in this figure is different from the conventional system illustrated in FIG. 1 in that a continuable communication management server 10 is connected to the system. The continuable communication management server 10 manages continuable reproduction information (view information) to transfer information about a previous view mode on a user's view terminal to a different view terminal of the same user.

In FIG. 10, a video distribution server 2 for mobile phone, a mobile phone menu server 3, a video distribution server 4 for network TV receiver, and a network TV menu server 5 are connected to a network 1 such as the Internet. The video distribution server 2 for mobile phone functions as a streaming server to provide video content in response to a request from a mobile phone via the network 1, and it is referred to as a “mobile phone video streaming server 2”. The mobile phone menu server 3 functions as a Web server to provide video list data in response to a request from a mobile phone via the network 1. The video distribution server 4 for network TV receiver functions as a streaming server to provide a video content in response to a request from a network TV receiver via the network 1, and it is referred to as a “network TV video streaming server 4”. The network TV menu server 5 functions as a Web server to provide video list data in response to a request from a network TV receiver via the network 1.

One or more continuable communication management servers 10 are connected to the network 1. When multiple continuable communication management servers 10 are connected, servers of different mobile phone operators or different internet providers may be included in accordance with the network. The continuable communication management server 10 manages the viewing state of each of users as continuable reproduction information. When multiple continuable communication management servers 10 are connected, the view information items can be shared among them for dispersion management.

To the network 1 is also connected a network 6 provided by a mobile phone operator and a network 7 provided by an internet service provider (ISP). A first view terminal 8, which is a mobile phone in this example, is connected to the mobile phone video distribution server 2, the mobile phone menu server 3, and the continuable communication management server 10 via the network 6 and the network 1. A second view terminal 9, which is a network TV receiver in this example, is connected to the network TV video distribution server 4, the network TV menu server 5, and the continuable communication management server 10 via the network 7 and the network 1.

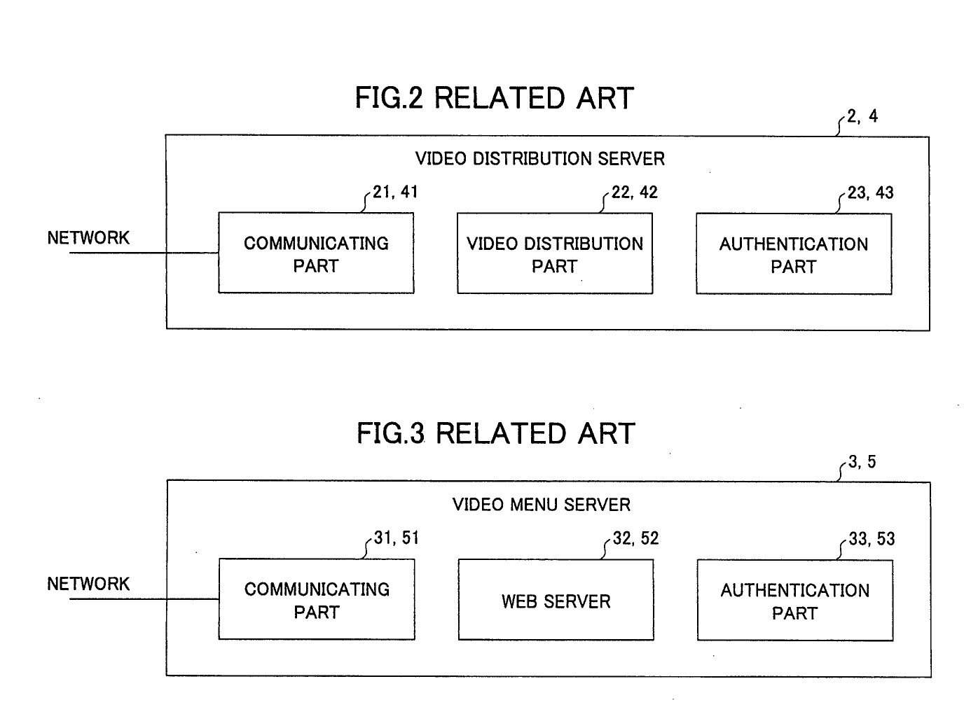

The structures of the video streaming servers (i.e., the mobile phone video distribution server 2 and the network TV video distribution server 4) are the same as that illustrated in FIG. 2.

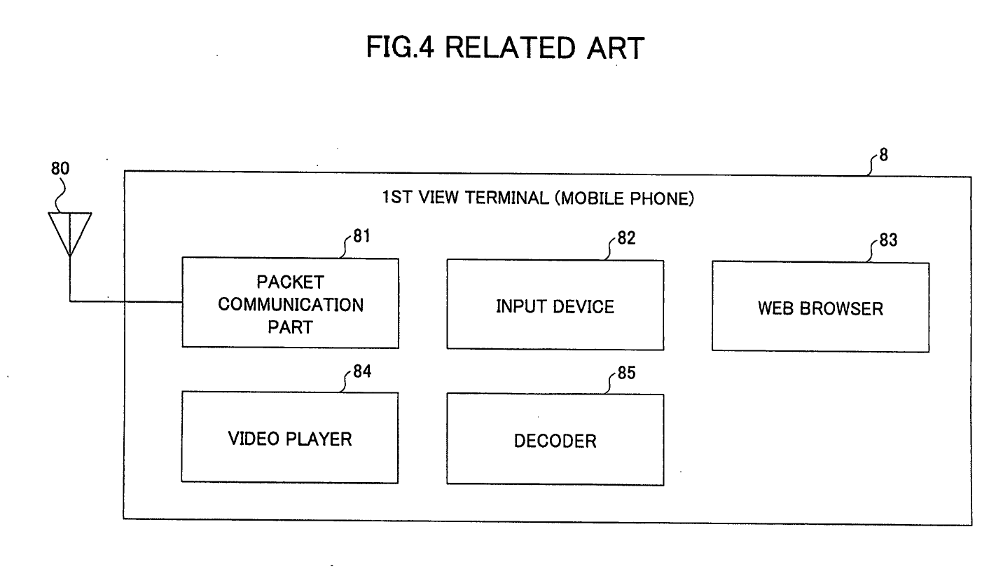

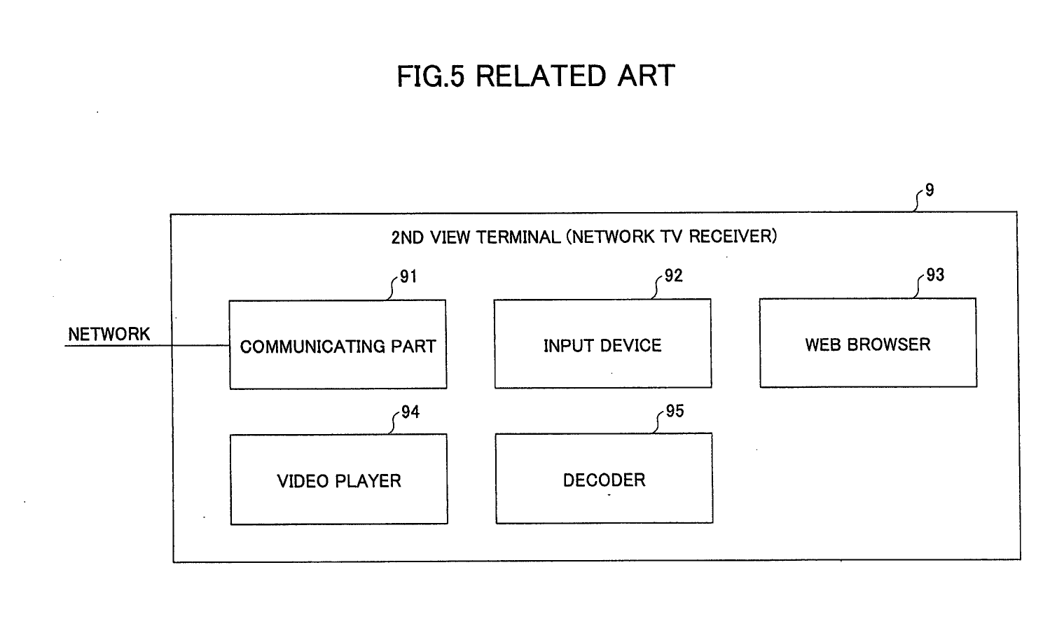

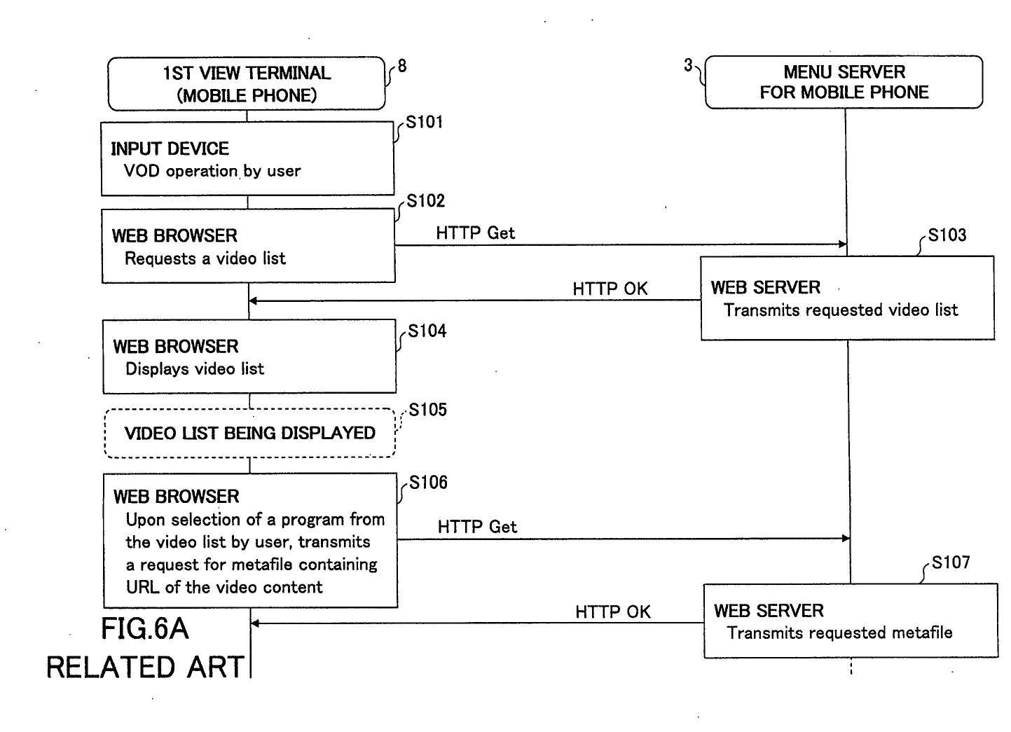

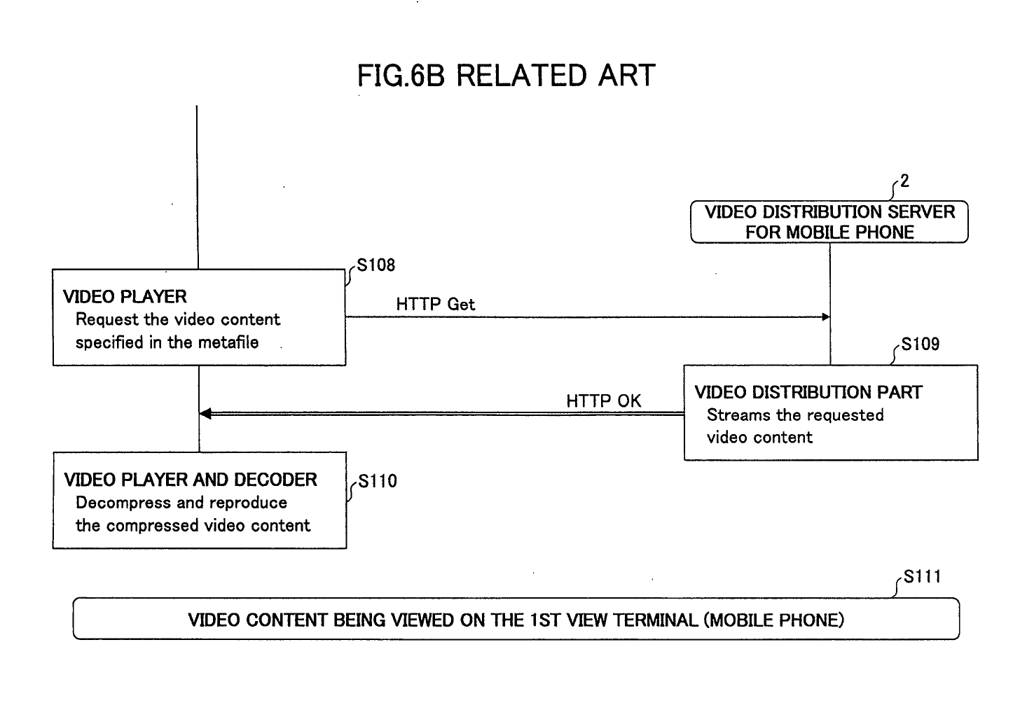

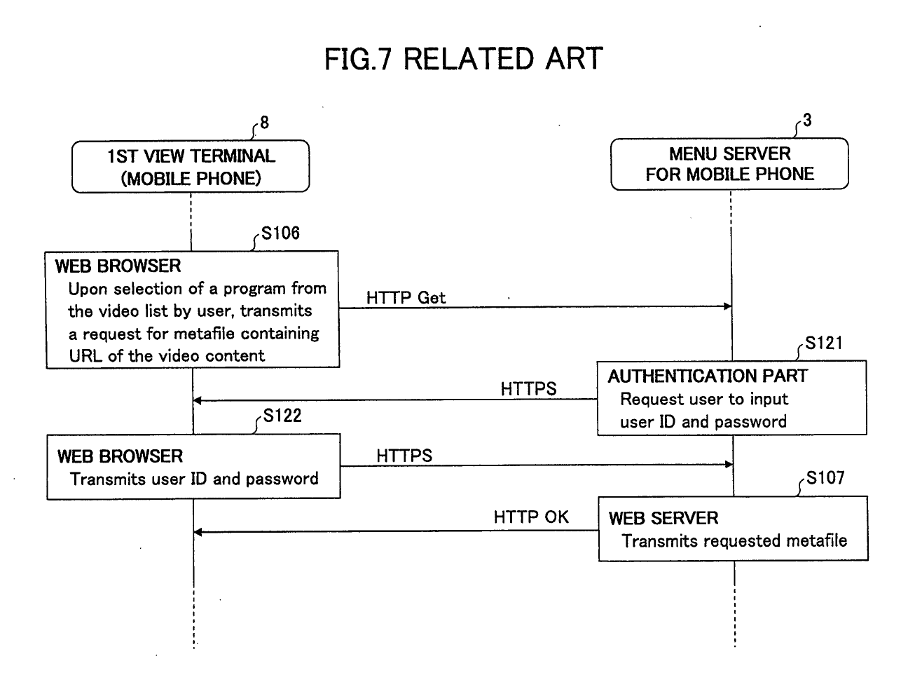

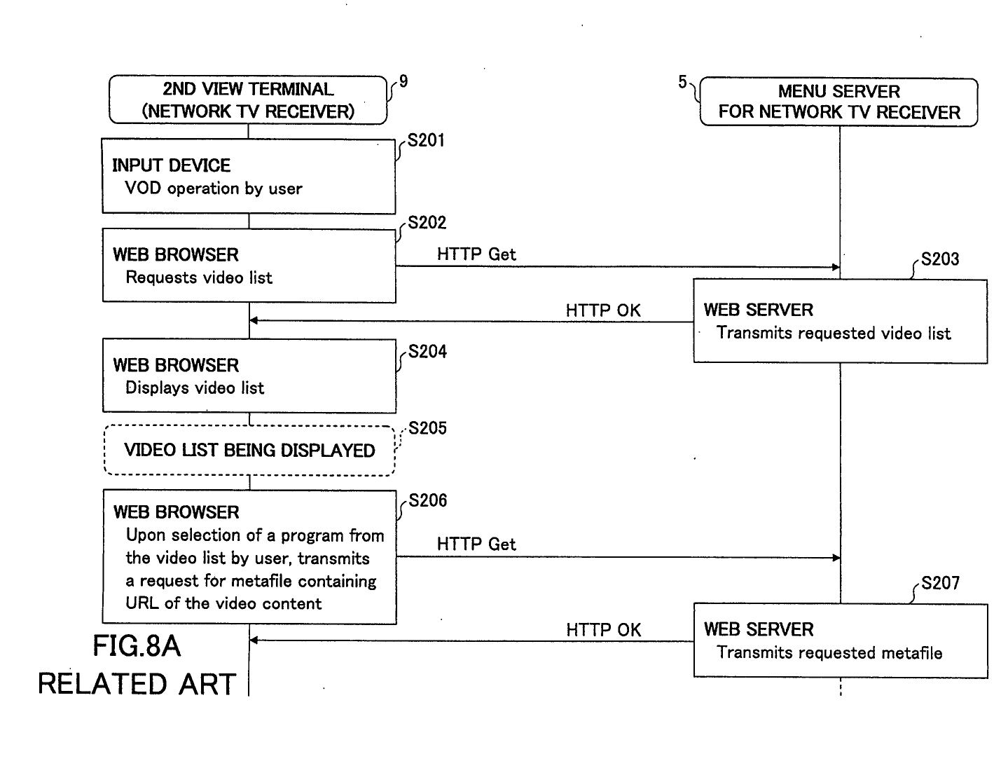

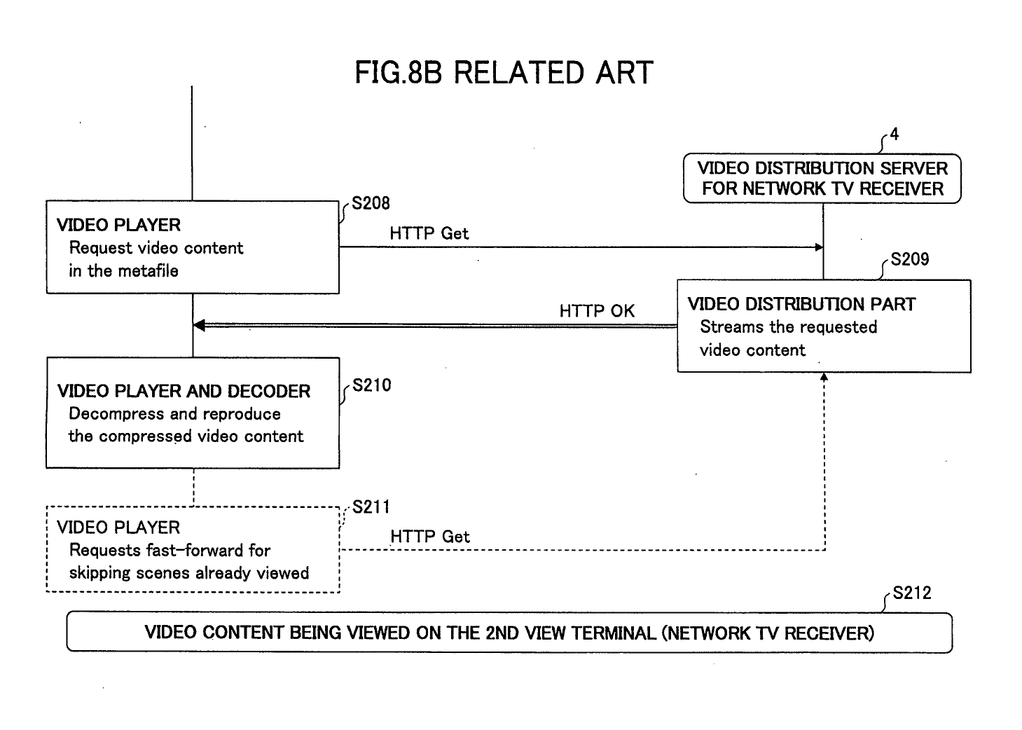

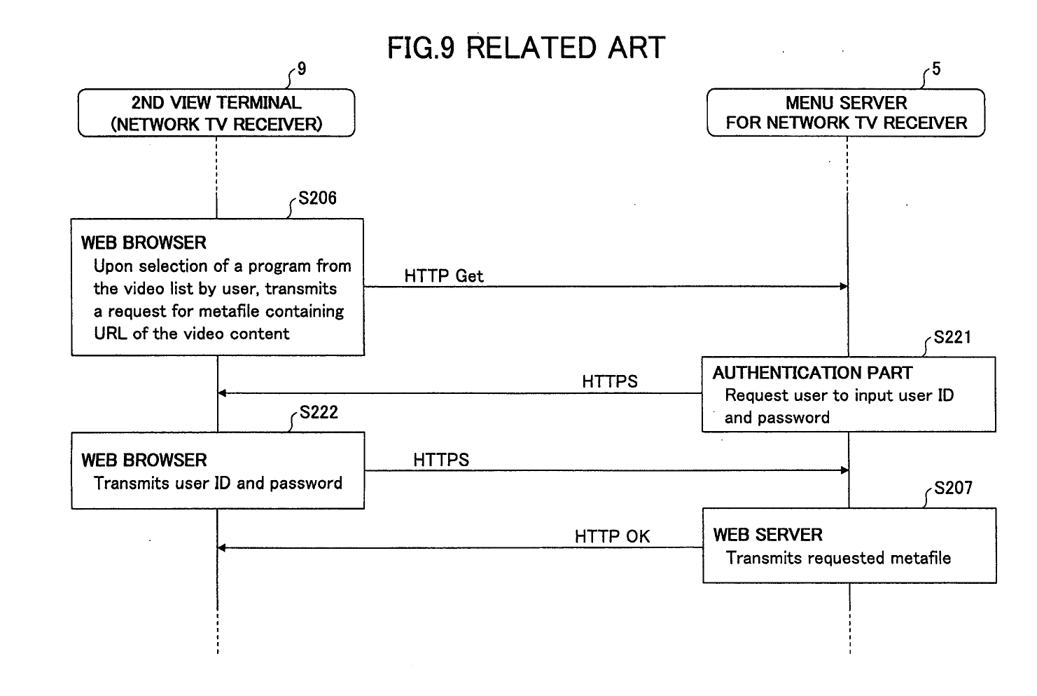

The structures of the video menu server (i.e., the mobile phone menu server 3 and the network TV menu server 5) are the same as that illustrated in FIG. 3. The structure of the first view terminal 8 is the same as that illustrated in FIG. 4, and the structure of the second view terminal 9 is the same as that illustrated in FIG. 5.

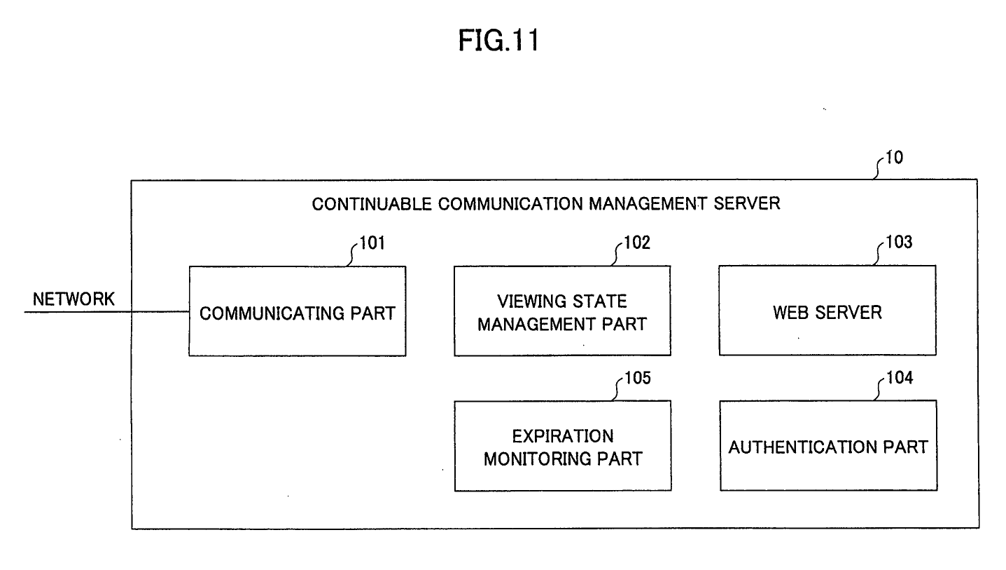

FIG. 11 illustrates the structure of the major part of the continuable communication management server 10. The continuable communication management server 10 has a communicating part (or communication device) 101 for carrying out communications via the network 1, and a viewing state management part (or viewing manager) 102 for managing the view information of each of the continuable communication management servers 10 connected to the network 1. The continuable communication management server 10 also has a Web server part 103, an authentication part 104, and an expiration monitoring part 105. The Web server part 103 provides a Web page in response to a request. The authentication part 104 carries out an authentication process when required for server access. The expiration monitoring part 105 deletes an expired data item in the view information, which data item is maintained in the viewing state management data for a prescribed time period even after a user has finished watching the video content.

The information items and functions managed and required by the continuable communication management server 10 are listed below. Items (1)-(3), (5) and (6) listed below are managed for individual users, and item (4) is information used in common in the system.
(1) Storing and managing information items necessary for continuable view, such information items including the video content a user is currently viewing and the view location (elapsed time from the head of the content);
(2) Determination if a user requesting a video list is currently viewing content on a different view terminal;
(3) Adding a screen interface to allow a user currently viewing content on a view terminal to input a continuable view request to continue viewing the content on a different view terminal;
(4) Managing content file name and the location of a same content for each of the view terminals;
(5) Managing login identifier and password designated for each of the service providers and network operators when performing authentication for the users; and
(6) Function for responding to authentication requests from service providers and network operators when performing login operations for the users.

In addition, continuable communications can be realized between different view modes. For example, view operations on a mobile phone (the first view terminal) can be appropriately succeeded by view operations on a network TV receiver (the second view terminal) even under the following circumstances.
(1) Business entities providing connection to the network are different (e.g., a mobile phone operator and an internet service provider);
(2) Functions and performance are different among view terminals; and
(3) Video streaming servers belong to different video stream service providers.

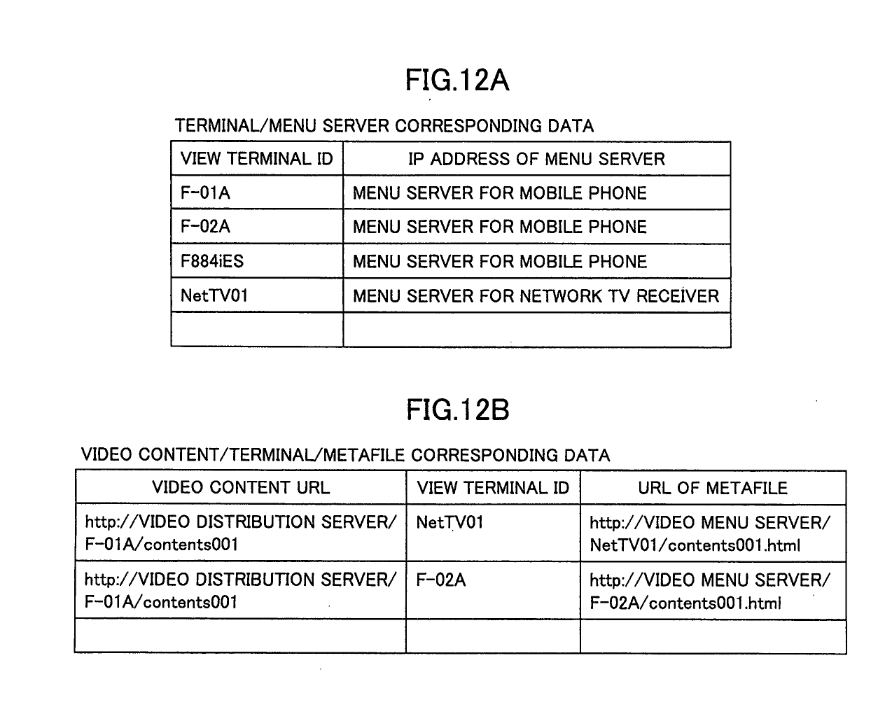

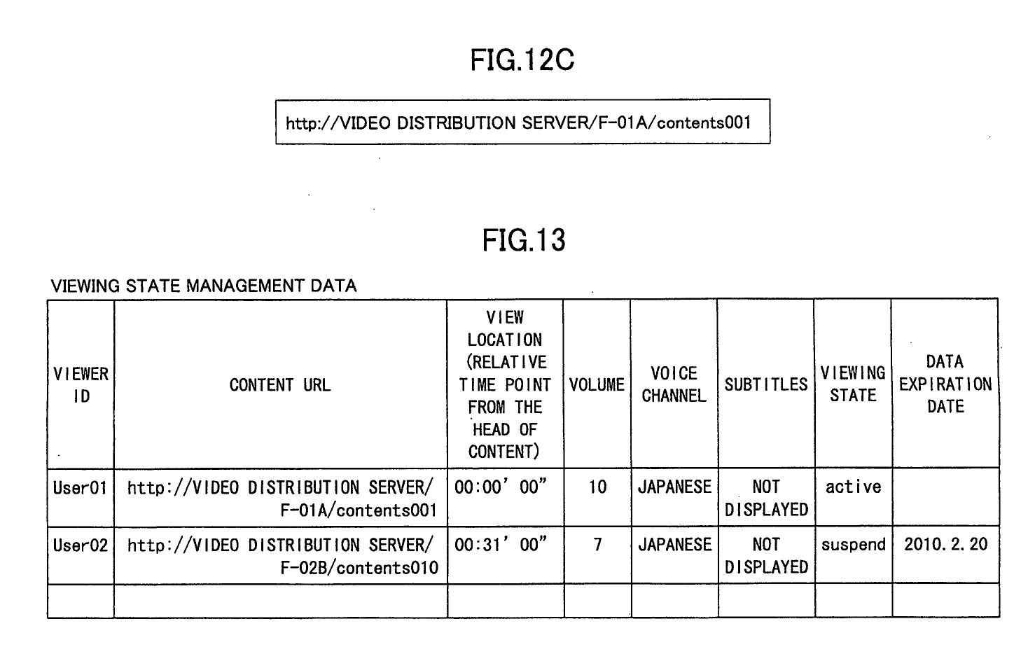

FIG. 12A through FIG. 12C illustrate examples of data items stored in the Web server part 103 of the continuable communication management server 10.

FIG. 12A illustrates terminal-to-menu server corresponding data items including individual view terminal IDs in association with the IP addresses of the corresponding menu servers. The Web server part 103 of the continuable communication management server 10 uses the terminal-to-menu server corresponding data items to determine target menu servers for the view terminals (including the first view terminal 8 and the second view terminal 9) accessing the servers based upon the identifiers when performing proxy access to the menu servers.

FIG. 12B illustrates video content/terminal/metafile corresponding data items representing association between video content URLs, view terminal IDs, and metafile URLs. FIG. 12C illustrates an example of the metafile referred to by the metafile URL, which metafile indicates the address on the video streaming server. The metafile extension is, for example, “.cpc”. The Web server part 103 of the continuable communication management server 10 uses the video content/terminal/metafile corresponding data items illustrated in FIG. 12B to set a linked destination when adding a “CONTINUABLE VIEW” button to the menu list to be provided to the view terminal. Video contents are automatically selected according to the capability of the view terminal by choosing the video contents in advance taking into account the screen size, the frame rate, the number of colors, the resolution, the compression format, the steaming band, etc. When two or more video streaming servers store the same video contents, the optimum video streaming sever can be selected based upon the network route to the view terminal, the network congestion, or other factors. FIG. 13 illustrates data items held in the viewing state management part 102 of the continuable communication management server 10. The viewing state management data includes “viewer ID”, “content URL”, “view location”, “volume”, “voice channel”, and “subtitles”. In addition to these data items, “viewing state” indicating ACTIVE state or SUSPENDED state is also included to maintain the video data for a prescribed time period even after the user finishes watching the video content, together with “expiration date” indicating the expiration of the data preservation. These data items are registered and managed by the viewing state management part 102 based on reports from view terminals (including the first view terminal 8 and the second view terminal 9). The expiration monitoring part 105 deletes time-expired data items.

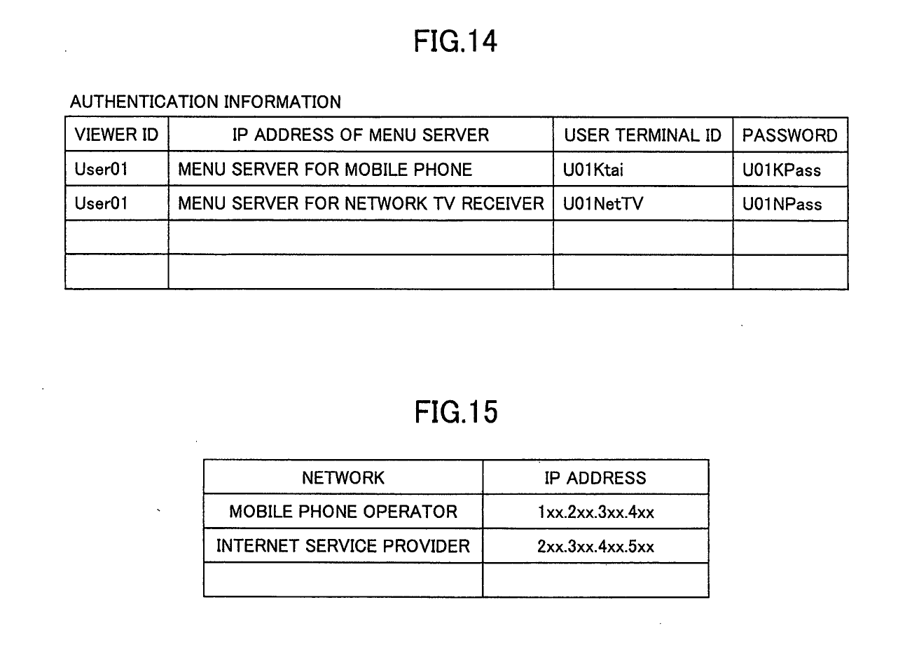

FIG. 14 illustrates data items held in the authentication part 104 of the continuable communication management server 10. The authentication information (i.e., login information) includes “viewer ID”, “menu server IP address”, “user terminal ID”, and “password”.

FIG. 15 illustrates an example of a continuable communication management server list stored in view terminals (including the first view terminal 8 and the second view terminal 9). If only one continuable communication management server 10 is connected to the system, the IP address of that continuable communication management server 10 is held. If multiple continuable communication management servers 10 are used, the IP addresses of the individual continuable communication management servers are associated with the corresponding networks to allow the view terminals to select an appropriate IP address according to the network environment.

Each of the view terminals holds the own viewer ID and the own view terminal ID (user terminal ID) inside.

### <Operations>

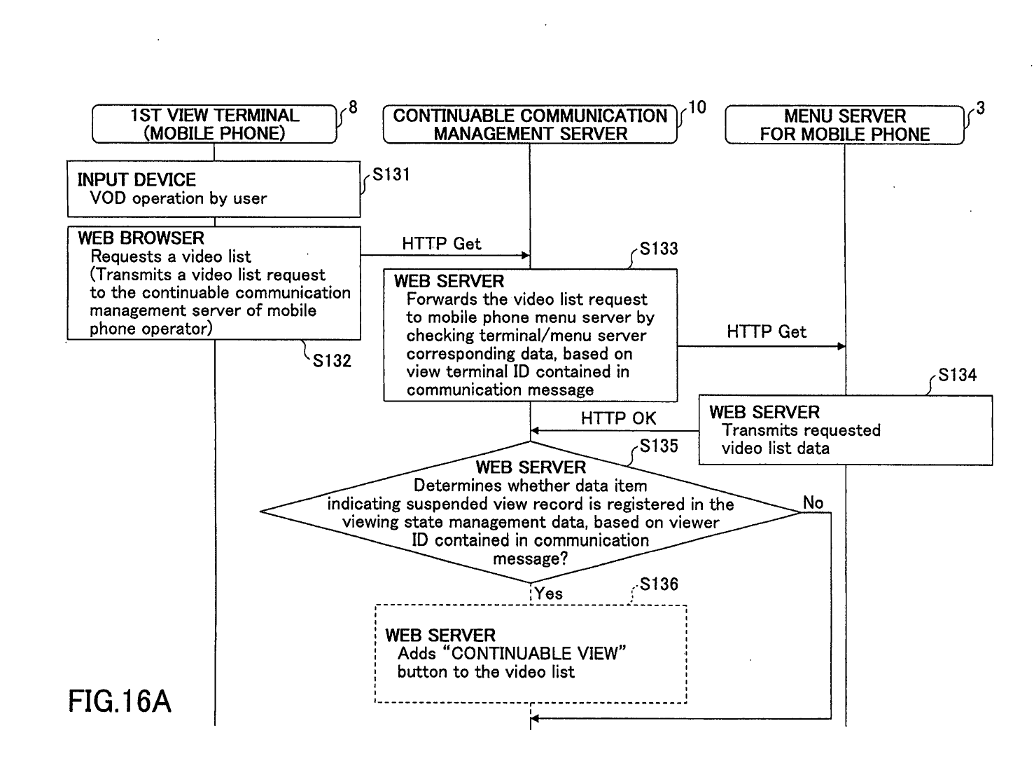

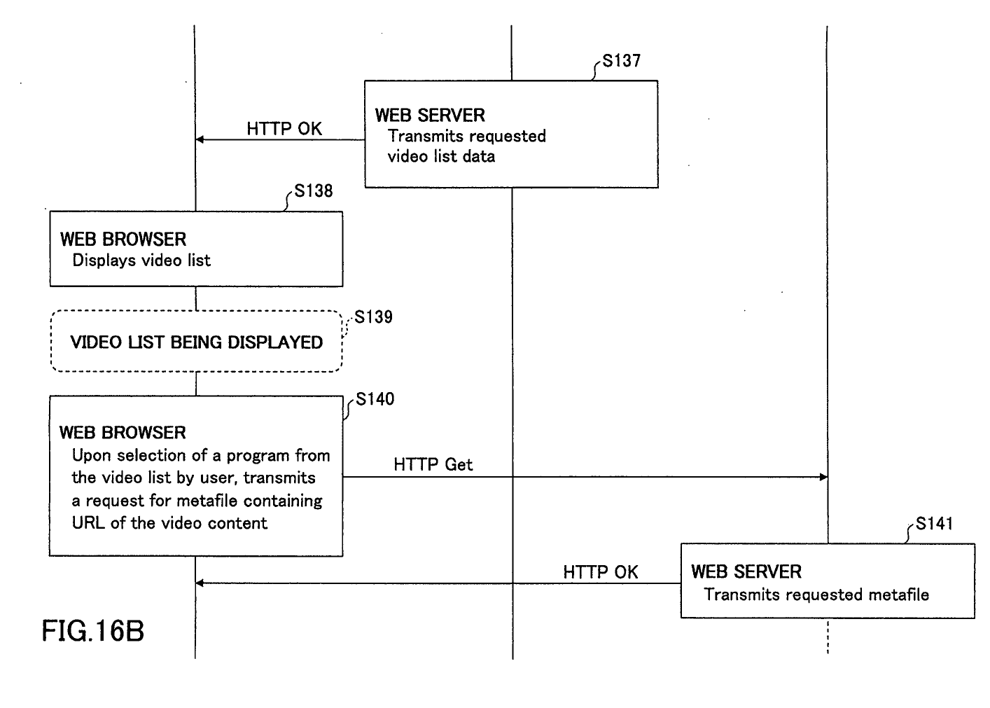

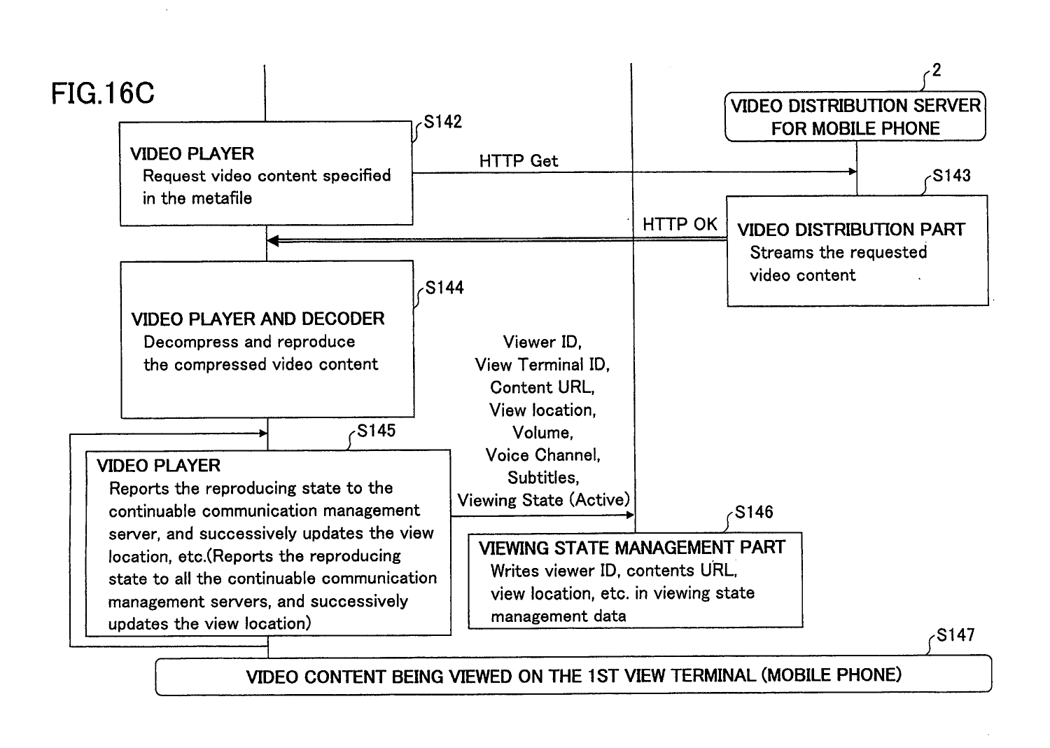

FIG. 16A through FIG. 16C are sequence diagrams of a process for viewing video content on a mobile phone in the system of the embodiment.

In FIG. 16A, when a user conducts a VOD (Video on Demand) operation on the first view terminal (e.g., mobile phone) 8 using the input device 82 (S131), a video list request is transmitted from the Web browser 83 to the continuable communication management server 10 (S132). If a single continuable communication management server 10 is used in the system, the video list request is transmitted to the IP address of that continuable communication management server 10. If multiple continuable communication management servers 10 are connected, the first view terminal 8 selects a continuable communication management server 10 provided by a mobile phone operator from the continuable communication management server list (FIG. 15) and transmits the request to the selected server.

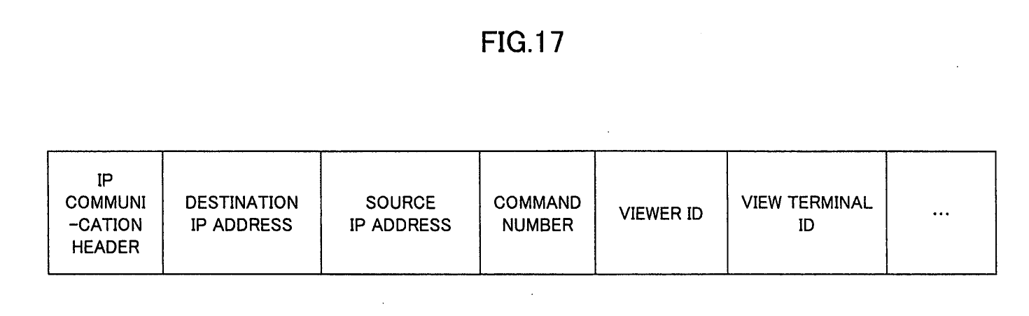

FIG. 17 illustrates a data structure of the communication message transmitted as a video list request from the first view terminal 8 to the continuable communication management server 10. The message includes information items of “IP communication header”, “destination IP address”, “source IP address”, “command number”, “viewer ID”, and “view terminal ID”. The command number is a code for identifying the contents of the communication message.

Returning to FIG. 16A, the Web server part 103 of the continuable communication management server 10 checks the terminal-to-menu server corresponding data (see FIG. 12A) to select the corresponding mobile phone menu server 3 based upon the view terminal ID contained in the communication message (FIG. 17), and forwards the video list request to the selected mobile phone menu server 3 (S133).

In response to the request, the Web server part 32 of the mobile phone menu server 3 transmits the requested video list data to the continuable communication management server 10 (S134).

The Web server part 103 of the continuable communication management server 10 checks the viewing state management data (FIG. 13) based upon the view ID contained in the communication message (FIG. 17) to determine if a data item with “SUSPENDED” state indicating a suspended view record is registered (S135). If there is a data item indicating the suspended view record (YES in S135), a “CONTINUABLW VIEW” button is to be added to the video list (S136). In this example, it is assumed that there is no data item with a suspended view record.

If there is no data item indicating the suspended view record (NO in S135), the process proceeds to FIG. 16B and the Web server part 103 of the continuable communication management server 10 transmits the video list data acquired from the mobile phone menu server 3 to the first view terminal 8 without processing the video list data (S137).

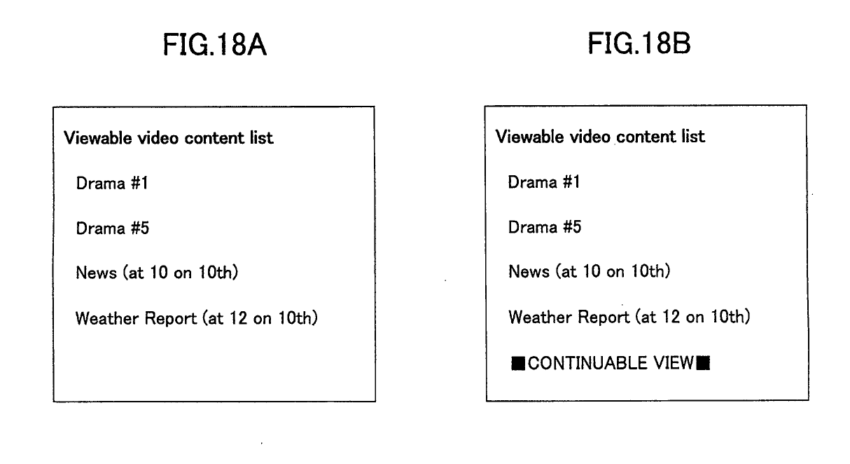

The Web browser 83 of the first view terminal 8 displays the video list based upon the received video list data (S138), and thus the video list is displayed on the first view terminal 8 (S139). FIG. 18A illustrates an example of the displayed video list (a list of viewable video contents).

Returning to FIG. 16B, when a program is selected by the user from the video list via the Web browser 83 of the first view terminal 8, the Web browser 83 requests the mobile phone menu server 3 to supply a metafile containing the URL of the selected video content (S140).

In response to the request, the Web server part 32 of the mobile phone menu server 3 transmits the requested metafile to the Web browser 83 of the first view terminal 8 (S141).

Then, in FIG. 16C, the video player 84 of the first view terminal 8 requests the mobile phone video streaming server 2 to supply the video content designated by the metafile (S142).

In response to the request, the video distribution part 22 of the mobile phone video streaming server 2 streams the requested video content to the first view terminal 8 (S143).

The video player 84 and the decoder 85 of the first view terminal 8 decompress the compressed data to reproduce the received video content (S144).

Then, the video player 84 of the first view terminal 8 reports the reproducing state to the continuable communication management server 10, while successively updating the view location (S145).

The report transmitted from the video player 84 of the first view terminal 8 to the continuable communication management server 10 contains the viewer ID, the view terminal ID, the content URL, the view location, the volume, the voice channel, the subtitles, and the viewing state (indicating “Active”).

The viewing state management part 102 of the continuable communication management server 10 registers the viewer ID, the content URL, the view location, the volume, the voice channel, the subtitles, the viewing state (Active) in the viewing state management data illustrated in FIG. 13 (S146).

Thus, the state in which a specific video content is being viewed on the first view terminal 8 is recognized and managed in the system (S147).

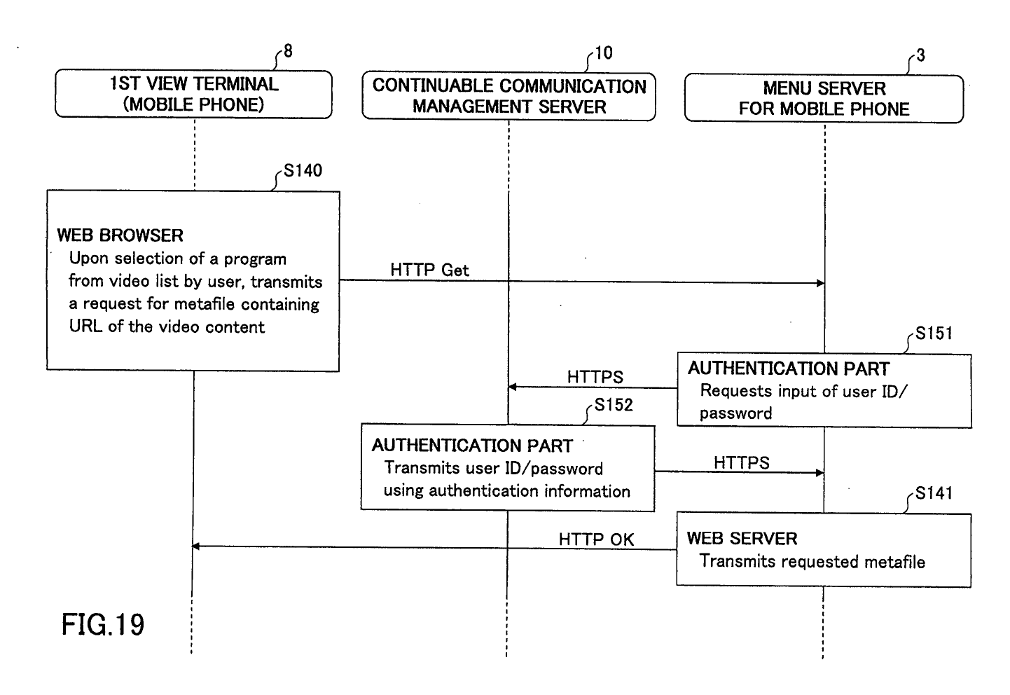

FIG. 19 is a sequence diagram illustrating a modification of a process when authentication is performed for allowing video content to be viewed on the mobile phone. The authentication process is inserted between S140 and S141 illustrated in FIG. 16B, and the other steps are the same as those illustrated in FIG. 16A through FIG. 16C.

In FIG. 19, after transmission of the request for the metafile from the Web browser 83 of the first view terminal 8 (S140), the authentication part 33 of the mobile phone menu server 3 requests the continuable communication management server 10 to input the user ID and the password (S151).

The authentication part 104 of the continuable communication management server 104 transmits the user ID and the password to the authentication part 33 of the mobile phone menu server 3 using the authentication information illustrated in FIG. 14 (S152).

When the authentication is successfully performed, the Web server part 32 of the mobile phone menu server 3 transmits the requested metafile to the Web browser part 83 of the first view terminal 8 (S141).

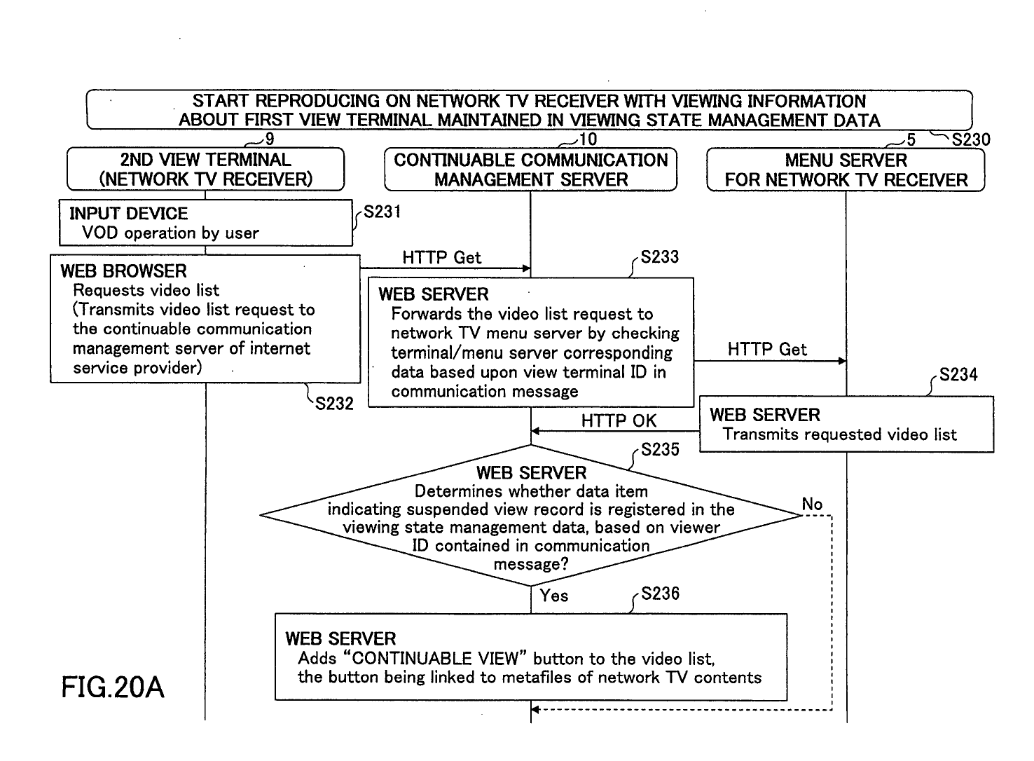

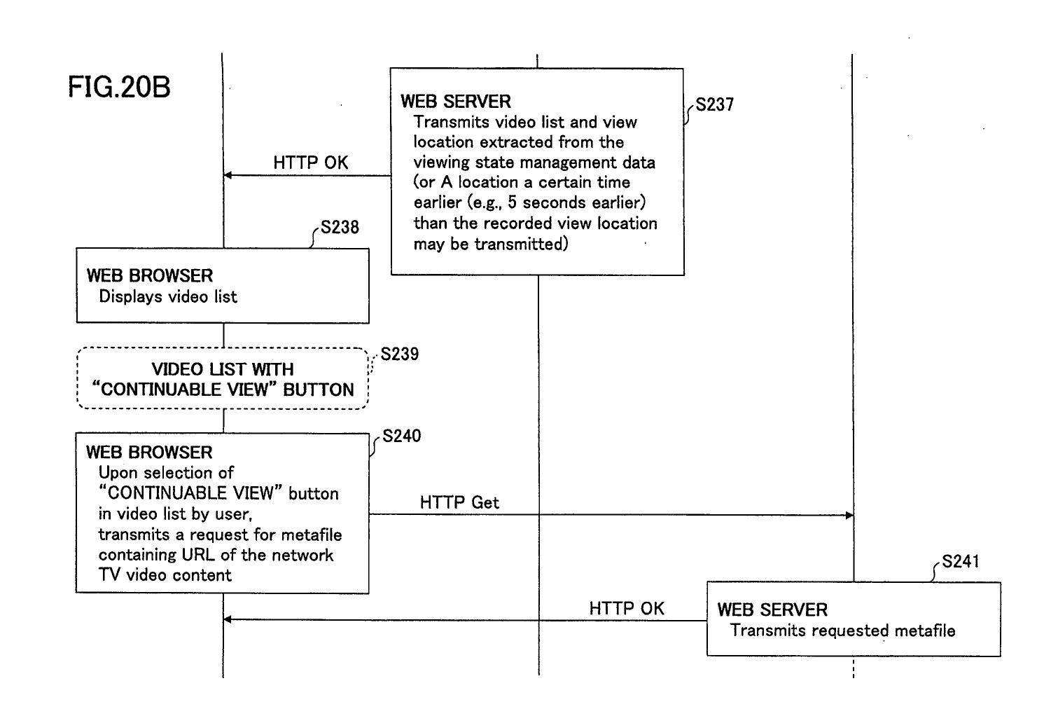

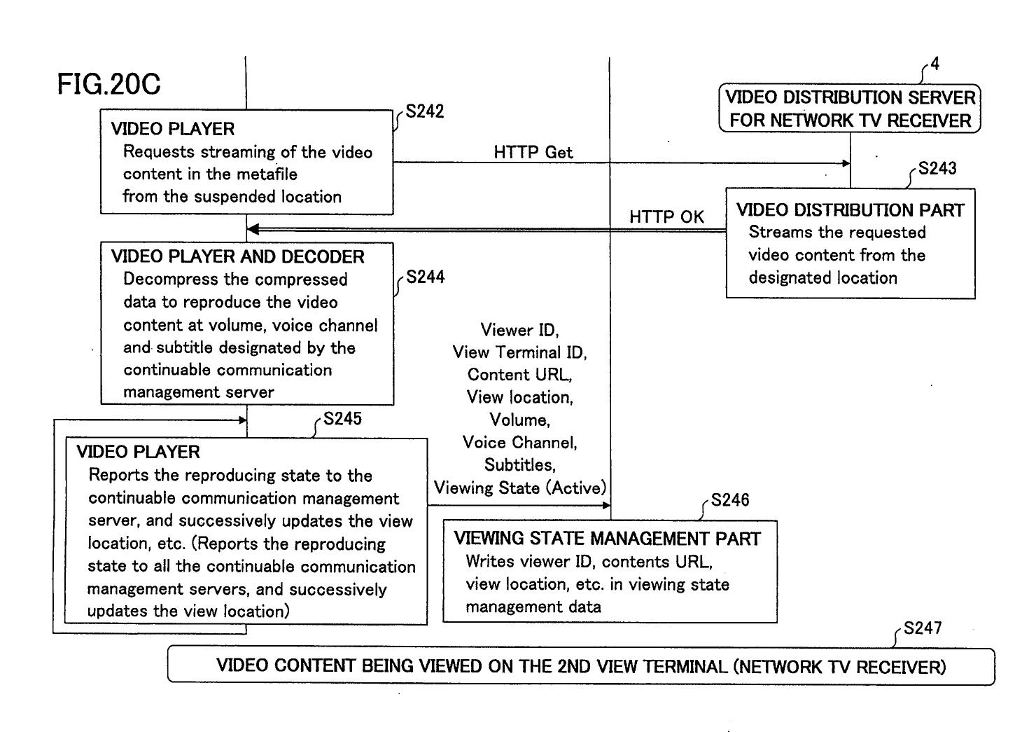

FIG. 20A through FIG. 20C are sequence diagrams illustrating a process for allowing a user to continuously view suspended video content on a network TV receiver.

In FIG. 20A, it is assumed that a user comes back home while viewing video content on the first view terminal (e.g., the mobile phone) 8

(S230).

When a user conducts a VOD (Video on Demand) operation on the second view terminal (e.g., network TV receiver) 9 using the input device 92 (S231), a video list request is transmitted from the Web browser 93 to the continuable communication management server 10 (S232). If a single continuable communication management server 10 is used in the system, the video list request is transmitted to the IP address of that continuable communication management server 10. If multiple continuable communication management servers 10 are connected, the first view terminal 8 selects a continuable communication management server 10 provided by a mobile phone operator from the continuable communication management server list (FIG. 15) and transmits the request to the selected server.

In response to the request, the Web server part 103 of the continuable communication management server 10 checks the terminal-to-menu server corresponding data (see FIG. 12A) to select the corresponding network TV menu server 5 based upon the view terminal ID contained in the communication message (FIG. 17), and forwards the video list request to the selected network TV menu server 5 (S233).

In response to the request, the Web server part 52 of the network TV menu server 5 transmits the requested video list data to the continuable communication management server 10 (S234).

The Web server part 103 of the continuable communication management server 10 checks the viewing state management data (FIG. 13) based upon the view ID contained in the communication message (FIG. 17) to determine if a data item with “SUSPENDED” state indicating a suspended view record is registered (S235). If there is no data item indicating a suspended view record (NO in S235), the video list data is not processed. In this example, it is assumed that a data item indicating the suspended view record is registered.

If there a data item indicating the suspended view record (YES in S235), the Web server part 103 of the continuable communication management server 10 adds a “CONTINUABLE VIEW” button to the video list and sets a metafile of the corresponding network TV content as a linked destination of the “CONTINUABLE VIEW” button (S236). In other words, based upon the view terminal ID and the URL of the suspended video content (with the “SUSPENDED” state) in the viewing state management data (FIG. 13), the URL of the corresponding metafile is acquired from the video content/terminal/metafile corresponding data (FIG. 12B) and set as a linked destination.

In FIG. 20B, the Web server part 103 of the continuable communication management server 10 transmits the video list, together with the view location information recorded in the viewing state management data (FIG. 13), to the Web browser 93 of the second view terminal 9 (S237). A view location at a prescribed time (5 seconds, for example) earlier than that recorded in the viewing state management data (FIG. 13) may be transmitted, taking into account the situation where the user may miss watching the last part when terminating the playback on the mobile terminal in the middle of the video content to change the view device to the network TV receiver. In addition, only the video part or the audio part of the view information may be transferred to the second view terminal depending on the ability of the view terminal.

The Web browser 93 of the second view terminal 9 displays the video list based upon the received video list data (S238), and thus the video list is displayed on the second view terminal (S239). FIG. 18B illustrates an example of the displayed video list (a list of viewable video contents), which is displayed together with the “CONTINUABLE VIEW” button.

Returning to FIG. 20B, when the “CONTINUABLE VIEW” button is selected by the user from the video list via the Web browser 93 of the second view terminal 9, a request for a metafile containing the URL of the network TV video content corresponding to the suspended video content is transmitted to the network TV menu server 5 (S240).

In response to the request, the Web server part 52 of the network TV menu server 5 transmits the requested metafile to the Web browser 93 of the second view terminal 9 (S241).

In FIG. 20C, the video player 94 of the second view terminal 9 requests the network TV video streaming server 4 to supply the video content designated by the metafile from the suspended location (S242).

In response to the request, the video distribution part 42 of the network TV video streaming server 4 streams the requested video content to the second view terminal 9 from the designated location (S243).

The video player 94 and the decoder 95 of the second view terminal 9 decompress the compressed data to reproduce the received video content having the volume, the voice channel, the subtitles, and other parameters designated by the continuable communication management server 10 (S244).

Then, the video player 94 of the second view terminal 9 reports the reproducing state to the continuable communication management server 10, while successively updating the view location (S245). The report transmitted from the video player 94 of the second view terminal 9 to the continuable communication management server 10 contains the viewer ID, the view terminal ID, the content URL, the view location, the volume, the voice channel, the subtitles, and the viewing state (indicating “Active”).

The viewing state management part 102 of the continuable communication management server 10 registers the viewer ID, the content URL, the view location, the volume, the voice channel, the subtitles, and the viewing state (Active) in the viewing state management data illustrated in FIG. 13 (S246).

Thus, the state in which a specific video content is being viewed on the second view terminal 9 is recognized and managed in the system (S247).

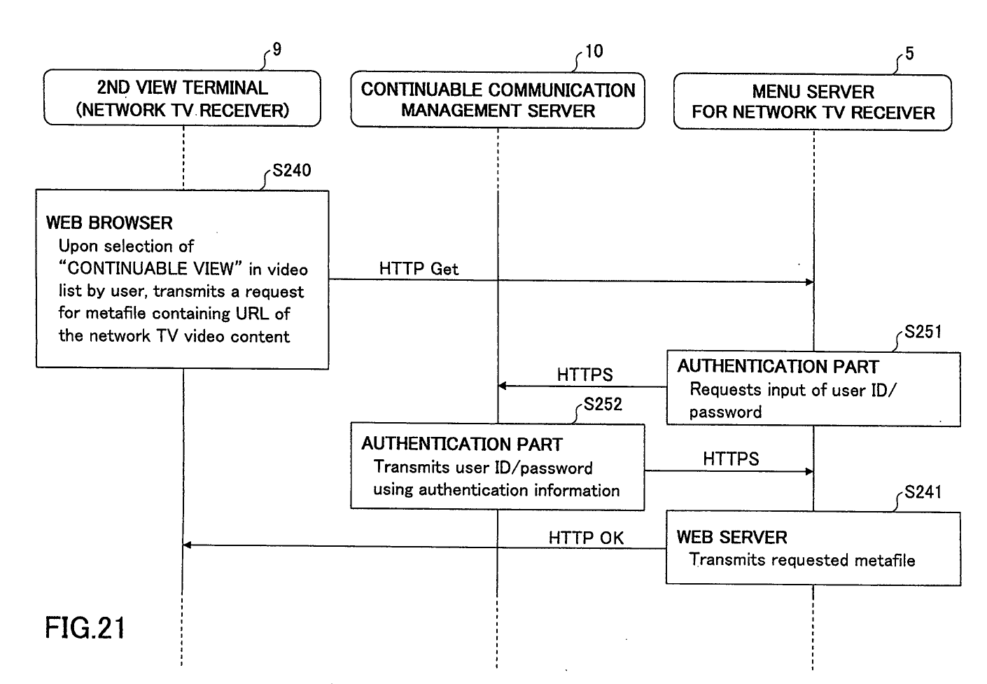

FIG. 21 is a sequence diagram illustrating a modification of a process when authentication is performed for allowing video content to be viewed on the network TV receiver. The authentication process is inserted between S240 and S241 illustrated in FIG. 20B, and the other steps are the same as those illustrated in FIG. 20A through FIG. 20C.

In FIG. 21, after transmission of the request for the metafile from the Web browser 93 of the second view terminal 9 (S240), the authentication part 53 of the network TV menu server 5 requests the continuable communication management server 10 to input the user ID and the password (S251).

The authentication part 104 of the continuable communication management server 104 transmits the user ID and the password to the authentication part 53 of the network TV menu server 5 using the authentication information illustrated in FIG. 14 (S252).

When the authentication is successfully performed, the Web server part 52 of the network TV menu server 5 transmits the requested metafile to the Web browser part 93 of the second view terminal 9 (S241).

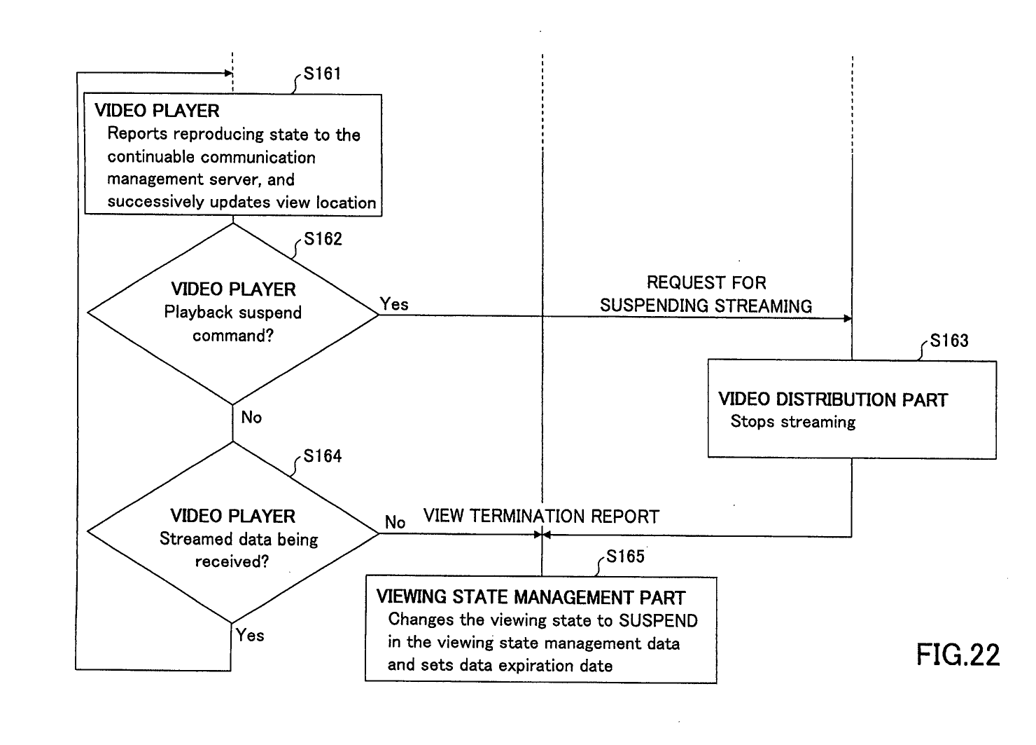

FIG. 22 is a sequence diagram illustrating termination of streaming on the view terminal, which process follows the end of FIG. 16C and FIG. 20C.

In FIG. 22, the video player 84 of the first view terminal 8 and the video player 94 of the second view terminal 9 report the reproducing state to the continuable communication management server 10, while updating the view location (S161).

Then, the video player 84 of the first view terminal 8 and the video player 94 of the second view terminal 9 determine if a playback suspending command has been issued (S162).

If the playback suspending command has been issued (YES in S162), a streaming suspend request is transmitted to the corresponding video streaming server (the mobile phone video streaming server 2 or the network TV video streaming server 4) to cause the video streaming server (the mobile phone video streaming server 2 or the network TV video streaming server 4) to stop streaming (S163). The video streaming server reports the termination of viewing to the continuable communication management server 10.

If playback suspending command has not been issued (NO in F162), the video player 84 of the first view terminal 8 and the video player 94 of the second view terminal 9 determine if the streamed data are being received (S164).

If the streamed data are being received (YES in S164), the process returns to step S161 to report the reproducing state to the continuable communication management server 10. If the streamed data are not being received (NO in S164), a view termination report is transmitted to the continuable communication management server 10.

The viewing state management part 102 of the continuable communication management server 10 changes the viewing state of the corresponding viewing state management data item (FIG. 13) to “SUSPEND” and sets the data expiration date (S165). The expiration date is a prescribed number of days ahead (for example, a week ahead) from the suspended point of time.

The expiration date may be set at ten days ahead from the suspended time if the suspended video content is highly likely to be viewed again, for example, if it is determined from the attribute information of the video content that the suspended video content is in a series, if the view duration time exceeds a prescribed time (e.g., one hour), if the suspended video content is related to business content, or if the suspended content is related to a hobby. Alternatively, the expiration date may be set at five days ahead from the suspended time if the number of viewing state management data items registered in the server exceeds a prescribed number. Alternatively, the continuable communication management server 10 may be configured to transmit an inquiry to confirm if the user wishes to view the rest of the video content at a later time upon the termination of viewing at the first view terminal 8.

If the user does not wish to continue viewing, the data item of the video content may be deleted from the viewing state management data.

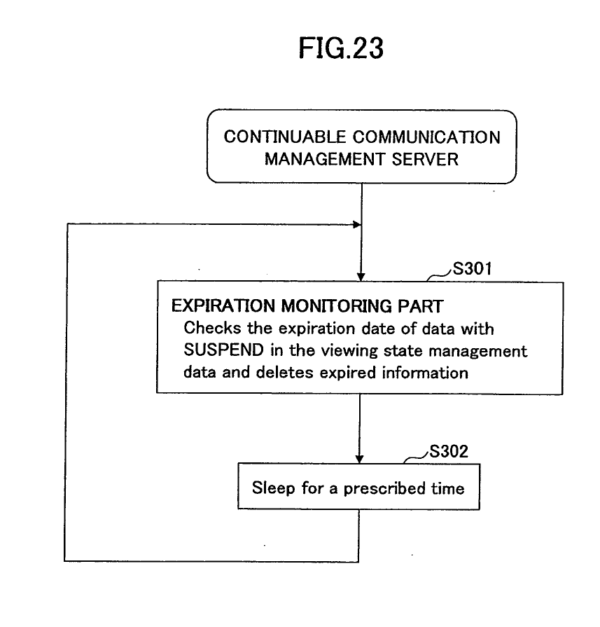

FIG. 23 is a sequence diagram of checking expiration of the viewing state management data items in the continuable communication management server 10. The expiration monitoring part 105 of the continuable communication management server 10 searches all the data items of the viewing state management data to check the expiration dates of the suspended video contents, and deletes the expired data items with the expiration date older than the current time (S301). Step S301 is repeated at prescribed time intervals (S302).

If the number of registered viewing state management data items exceeds a prescribed value, the expiration dates of the data items may be changed to be several days earlier, expect for the data items of the video contents with high likelihood of continuing viewing.

### <General Overview>

With the structure and the operations of the above-described embodiment, the user's action can be simplified when desiring to continue watching previously watched video content at a later time on a different terminal device. Especially, there are advantages listed below.

(1) User's manipulation can be simplified when viewing video content distributed from a video streaming server successively at different view terminals.

(2) Information about the viewing state of a user can be appropriately managed using a viewer ID and a view terminal ID.

(3) Since the viewing state management data (FIG. 13) including data items of volume, voice channel, subtitles, etc., are registered in the viewing state management part 102 of the continuable communication management server 10 and constantly updated, and since these data items are used to reproduce video content, view setting desired by the user can be continuably succeeded.

(4) A single or multiple continuable communication management servers can be used to realize dispersion management. For example, prescribed IP addresses of a mobile phone operator and an internet service provider are assigned to continuable communication management servers. The IP address list of the continuable communication management servers used in the system is held by view terminals (8, 9). When a menu server is required, a corresponding continuable communication management server is selected from the IP address list to transmit a request to the menu server. When view information is registered, the view information is transmitted to and registered in all of the continuable communication management servers in the IP address list to enable continuable reproduction.

(5) View terminals are associated with appropriate menu servers based on the terminal-to-menu server corresponding data (FIG. 12A), and the optimum video contents can be delivered to the view terminals.

(6) View terminals are associated with appropriate menu servers based on the terminal-to-menu server corresponding data (FIG. 12A), and video content taking media information into account can be delivered to each of the view terminals.

(7) Because a metafile (FIG. 12C) linked to a menu contains server address information in the URL of the video content, the optimum menu server can be selected for each of the view terminals based on the terminal-to-menu server corresponding data (FIG. 12A).

(8) Authentication information (FIG. 14) of a mobile phone operator or an internet service provider is held in the continuable communication management server 10 to carry out authentication with respect to the menu server on behalf of a view terminal, and accordingly, user manipulation can be simplified.

(9) When previously watched video content is continuously watched on a different view terminal, a playback location several time units earlier than the view location registered in the viewing state management data (FIG. 13) is supplied from the continuable communication management server 10 to the different view terminal, thereby preventing several scenes from being lost when switching view terminals.

(10) By maintaining view information about streaming video content whose reproduction is suspended in the viewing state management data (FIG. 13) for a prescribed time period, the video content can be continued to be viewed even a certain time later. By adjusting the view information maintaining time, unlimited increase of the stored information items can be prevented.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present inventions have been described in detail, it should be understood that the various changes, substitutions, and alterations could be made hereto without departing from the spirit and scope of the invention.

What is claimed is:

1. A continuable communication management apparatus connected to a video content distribution system that includes a video distribution server configured to distribute a requested video content via a network and view terminals configured to receive and reproduce the distributed video content, the continuable communication management apparatus comprising:
a communication device to receive view information representing a reproduction state of a video content transmitted from an arbitrary view terminal,
a viewing manage to resister the view information;
a video list provider to, in response to a video list request transmitted from a view terminal, access a menu server to acquire the video list, determine if there is a video content with a suspended state designated by a user of the view terminal in the view information, and if there is a video content with the suspended state, add the video content with the suspended state as a candidate of continuable viewing to the video list, and transmit the added video list to the view terminal; and
reporting device configured to find an information item containing an indication of a view location of the video content with the suspended state from the view information and report the information item to the view terminal that has requested the video list.

2. The continuable communication management apparatus according to claim 1, wherein the viewing manger manages the view information using a user identification or a view terminal identification as an identification key for information lookup.

3. The continuable communication management apparatus according to claim 1, wherein the reporting device adds at least one of a volume, a voice channel, and subtitle information of a previously used view terminal to the view information and returns the added view information to the view terminal that has requested the video list.

4. The continuable communication management apparatus according to claim 1, wherein the communication device communicates with another continuable communication management apparatus with a same function to transmit and receive the view information to and from said other continuable communication management apparatus to manage the view information in a decentralized manner.

5. The continuable communication management apparatus according to claim 1, wherein the video list prover selects a video content in accordance with a capability of the view terminal on the basis of at least one of a screen size, a frame rate, a resolution, a compression scheme, a number of colors, and a streaming band.

6. The continuable communication management apparatus according to claim 1, wherein the communication device receives and transmits only a video image portion or an audio component portion of the view information depending on a capability of the view terminal.

7. The continuable communication management apparatus according to claim 1, wherein the reporting device selects one of a plurality of the video distribution servers storing same video contents based upon a network route to the view terminal or network congestion.

8. The continuable communication management apparatus according to claim 1, further comprising:
An authentication device to store login information required for authentication when accessing the menu server.

9. The continuable communication management apparatus according to claim 1, wherein the reporting device reports a view location at a prescribed time earlier than the registered view location in the view information to the view terminal that has requested the video list.

10. A continuable communication management method for controlling a continuable communication management apparatus connected to a video content distribution system that includes a video distribution server configured to distribute a requested video content via a network and view terminals configured to receive and reproduce the distributed video content, the method comprising:
receiving view information representing a reproduction state of a video content transmitted from an arbitrary view terminal and registering the view information;
receiving a video list request from a view terminal, accessing a menu server to acquire the video list, determining if there is a video content with a suspended state designated by a user of the view terminal in the view information, and if there is a video content with the suspended state, adding the video content with the suspended state as a candidate of continuable viewing to the video list, and transmitting the added video list to the view terminal; and
finding an information item containing an indication of a view location of the video content with the suspended state from the view information and transmitting the information item to the view terminal that requested the video list.

11. The continuable communication management method according to claim 10, wherein the view information is managed using a user identification or a view terminal identification as an identification key for information lookup.

12. The continuable communication management method according to claim 10, further comprising:
adding at least one of a volume, a voice channel, and subtitle information of a previously used view terminal to the view information and transmitting the added view information to the view terminal that has requested the video list.

13. The continuable communication management method according to claim 10, further comprising:
communicating with another continuable communication management apparatus with a same function to transmit and receive the view information to and from said other continuable communication management apparatus to manage the view information in a decentralized manner.

14. The continuable communication management method according to claim 10, wherein a video content is selected in accordance with a capability of the view terminal on the basis of at least one of a screen size, a frame rate, a resolution, a compression scheme, a number of colors, and a streaming band.

15. The continuable communication management method according to claim 10, wherein the view information about only a video image or an audio component is received depending on a capability of the view terminal.

16. The continuable communication management method according to claim 10, further comprising:
selecting one of a plurality of the video distribution servers storing same video contents based upon a network route to the view terminal or network congestion.

17. The continuable communication management method according to claim 10, further comprising:
storing login information required for authentication when accessing the menu server.

18. The continuable communication management method according to claim 10, wherein a view location at a prescribed time earlier than the registered view location in the view information is reported to the view terminal that has requested the video list.
